(19) United States
(12) Patent Application Publication
(10) Pub. No.: US 2017/0094968 A1
(43) Pub. Date: Apr. 6, 2017

(54) INCREASING YIELDS BY THE USE OF SOPHOROLIPIDS

(71) Applicant: Ewald SIEVERDING, St. Johann (DE)

(72) Inventor: Ewald SIEVERDING, St. Johann (DE)

(73) Assignee: Evonik Degussa GmbH, Essen (DE)

(21) Appl. No.: 15/311,217

(22) PCT Filed: Apr. 16, 2015
(86) PCT No.: PCT/EP2015/058244

§ 371 Date: Nov. 15, 2016

(30) Foreign Application Priority Data
May 16, 2014 (DE) 10 2014 209 346.5

(51) Int. Cl. A01N 43/16; A01N 37/34; A01N 43/84; A01N 43/653; A01N 35/04; A01N 43/54; A01N 37/10

(52) U.S. Cl. CPC A01N 43/16; A01N 43/54; A01N 37/34; A01N 37/10; A01N 43/653; A01N 35/04; A01N 43/84

(57) ABSTRACT

The invention relates to the use of sophorolipids for increasing the yield of crop plants.

### FIELD OF THE INVENTION

The invention relates to the use of sophorolipids for increasing the yield of agriculturally useful plants.

### STATE OF THE ART

Agriculturally useful plants, also referred to as crops, are currently being treated with a large number of compositions during their vegetation period. Thus, for example, one will use pesticides for protecting the crop against fungal pathogens, or for controlling attack by insects, or for eliminating undesirable accompanying flora which competes with the crop.

US 2005/0266036 A1 describes biological wetters which are produced by microbes for use against pests, for example nematodes. Here, the wetters or the microorganisms which produce the wetters are directly placed on the pests so as to control them directly, in the manner of biopesticides. Examples are only given for the use of rhamnolipids against houseflies, cockroaches and nematodes, and against existing fungal spores on pumpkin. It is described that rhamnolipids, owing to their cell-wall-penetrating activity, have pesticidal activity.

Sophorolipids have antimicrobial activities; US 2005/0164955 and US 2013/0085067 describe such activities against various human- and phytopathogenic organisms in the form of MIC (minimum inhibitory concentration) values, that is to say in artificial test systems.

In order to be able to assess the agricultural potential and the activities of substances, it is necessary to carry out not only laboratory and greenhouse experiments, but also realistic applications in agriculture, for example field trials.

U.S. Pat. No. 7,994,138 B2 describes rhamnolipids as insecticidal, herbicidal, fungicidal and nematodicidal active substances. Rhamnolipids are sold as biofungicides for example under the name ZONIX (from Jeneil Biotech, Saukville, Wis., USA).

Glycolipids such as, for example, sophorolipids and rhamnolipids, are known as pesticide adjuvants (that is to say additives which are not active themselves) JP 2012-530202, US 2012/0220464, US 2012/002241, US 2005/0266036. In these applications, the disease-controlling activity of the employed pesticides is enhanced. Nothing is mentioned about the production of biomass or fruit yield.

Synergism with reference to increased yields in agriculturally useful plants is not described in the prior art for sophorolipids together with pesticides.

In a more recent study, rhamnolipids have been characterized as immunostimulants in plants (Varnier et al., 2009: Bacterial rhamnolipids are novel MAMPs conferring resistance to Botrytis cinerea in grapevine. Plant Cell Environ. 32:178-193. There are negative reports on the risk that rhamnolipids might, in this context, have undesirable negative effects on biomass production and crop yield in crops, or that, owing to the induction of immune reactions in plants, the plant metabolism might be adversely affected, which could result in reduced yields and/or reduced quality of crop products. According to U.S. Pat. No. 7,994,138, rhamnolipids have phytotoxic (plant-injurious) side effects.

Fungicides of the novel class of carboximides are said to improve the grain yield of cereals following foliar application (Berduga, C. A. et al., “Effects of the SDHI fungicide bixafen on development and yield of wheat”, Julius-Kühn-Archiv 438 (2012) 295).

The disadvantage of all uses known from the prior art of glycolipids and in particular sophorolipids is that they are always employed in combination with pesticides. This is done as a function of or independently of disease incidence. Frequently, therefore, prophylactically.

It is an object of the present invention to increase the yield of crop plants.

### DESCRIPTION OF THE INVENTION

Surprisingly, it has been found that sophorolipids are capable of achieving this object.

The subject-matter of the present invention is therefore the use of sophorolipids for increasing the yield of agriculturally useful plants.

An advantage of the use according to the invention of sophorolipids is that yield increases in agriculturally useful plants are also obtained when the phytopathogen is not controlled and/or the disease symptoms are not altered.

A further advantage of the use according to the invention of sophorolipids is that pesticides, preferably fungicides, need not be used, even when corresponding disease symptoms as are caused by harmful organisms, preferably fungi, occur, while still achieving increased yields. Disadvantages of the use of pesticides such as, for example, side effects and additional costs, are thereby avoided.

Another advantage is that the use according to the invention of sophorolipids is not limited to application to the aerial parts of the plant which has already germinated and/or grown, but may also be used as a seed treatment product. The use as seed treatment product has the advantage that the application is technically simplified, for example because spraying onto a cereal field can be dispensed with. Another advantage is the use as seed treatment product because the application rate can be reduced.

A further advantage is the low ecotoxological potential of the sophorolipids, for example against the organisms Daphnia magna or Tetrahymena thermophila. This has the advantage that a corresponding yield increase need not be given up, even in areas where agriculture is regulated and/or restricted in respect of pesticide use.

Furthermore, sophorolipids are advantageous in food production because they are highly biodegradable (OECD 301 F), and no unacceptable metabolites are accumulated (OECD 303 A).

A further advantage of the use according to the invention of sophorolipids is that yields are increased even when sophorolipids are used as adjuvants as per US 2012/0220464. Here, the pesticides may be applied both prophylactically and curatively.

Preferably, agriculturally useful plants are used appropriately when they are infected with phytopathogenic organisms. Further preferably, the appropriate use of sophorolipids does not affect the disease symptoms caused by the phytopathogenic organisms.

Further preferably, the sophorolipids are employed in accordance with the invention in amounts of 50 to 1000 g/ha of active SL component, preferably of 75 to 750 g/ha and particularly preferably of 100 to 500 g/ha.

“Yield-increasing activity” relates to the enhanced formation of total biomass or parts of a crop plant such as, for example, root length and number of roots, or else to the shoot lengths, and/or it relates to more crop such as, for example, grain yields, and/or it relates to an improvement of the quality of the abovementioned plant parts.

Where reference is made within this invention to natural substances, for example glucose, the intention in principle is to refer to all isomers, and preferred are those isomers which occur naturally in each case, in the present case therefore D-(+)-glucose. As regards the definition of natural substances, reference is made to the scope of the “Dictionary of Natural Products”, Chapman and Hall/CRC Press, Taylor and Francis Group, e.g. in the online version from 2011: http://dnp.chemnetbase.com/.

The terms “agriculturally useful plants” or “crops”, are used synonymously within the scope of the invention. Agriculturally useful plants are grown in arable farming, fruit production and/or vegetable production and/or for obtaining renewable raw material for energy production, such as, for example, tree and forestry plantations, including cultivated tree and forestry plantations. Examples of crops are cereals, such as maize, wheat, barley, rye, oats, triticale, rice, and legumes such as soybeans, garden beans and others, tuber crops such as potatoes, root crops such as sugar beet, or crops such as oilseed rape, sunflower and others, fibre crops such as cotton and others, and energy plants such as Miscanthus, vegetables such as tomatoes, lettuce, cabbage and many others, fruit tree crops such as apples, pears, oranges, lemons and many others, or plantation crops such as coffee, tea, palms (all species), bananas and many others, and forestry crops. Forestry crops can be crops in tree nurseries and forestations.

Within the scope of the invention, plant diseases are understood as meaning disease symptoms caused by harmful organisms. Harmful organisms can be microscopic or microscopic in nature. Microscopic harmful organisms are, for example, phytopathogenic organisms, macroscopic harmful organisms are, for example, insect pests.

“Phytopathogenic organisms” may be, for example, bacteria, actinomycetes, nematodes, fungi and/or viruses, which may or may not cause disease symptoms, such as, for example, mildew, rust and the like, preferably microorganisms, preferably fungal organisms such as, for example, harmful fungi of the genera Blumeria, Erysiphe, Puccinia, Phakopsora, Hemileia, Uromyces, Oidium, Septoria, Fusarium, Rhizoctonia, Alternaria, Helminthosporium, Bipolaris, Thielaviopsis, Botrytis, Phytophthora, Venturia, Plasmopor, Peronospora, Mycospherella, Verticillium, Tilletia, Pythium and others.

Harmful insects may be those which destroy the crop plant biomass by foraging and/or chewing and/or sucking or otherwise, or which, as the result of such attacks on plants, generate damage directly or indirectly by transmitting diseases. They include larvae, beetles, flies, bugs, mites and the like.

Preferably, the sophorolipids and/or their compositions are employed in accordance with the invention jointly with pesticides which are directed against phytopathogenic organisms, preferably against fungal organisms.

Within the scope of the present invention, sophorolipids are understood as meaning the class of substances which is based on the natural substance sophorose, where the sophorose is derivatized with a hydroxy-fatty acid which has at least 6 and not more than 31 carbon atoms and which is optionally mono- or polyunsaturated.

Sophorose is a disaccharide of two glucose molecules which are linked glycosidically. This linkage is preferably a 1→2-glycosidic linkage, more preferably a 1→2-beta-glycosidic linkage. The diglucoside is furthermore preferably a bis-⁴C₁-diglucoside.

The glucose molecules, in turn, may be substituted independently of one another on the remaining hydroxyl groups, preferably etherified and/or esterified, particularly preferably substituted independently of each other at both C-6-hydroxyl groups. Preferred ether groups are methyl, ethyl, propyl and/or butyl ethers, with the methyl ethers being more preferred. Preferred esters are those of formic acid, acetic acid, propionic acid, butyric acid, valeric acid, isovaleric acid, adipic acid and/or isoadipic acid, more preferred are the acetates.

The hydroxy-fatty acid is glycosidically bonded (that is to say via the hydroxyl group) to the sophorose on the remaining anomeric hydroxyl group of the diglucoside, the hydroxy-fatty acid is preferably beta-glycosidically bonded, the hydroxy-fatty acid is particularly beta-glycosidically bonded to the 1→2-beta-diglucoside. The hydroxy-fatty acid preferably has a chain length of from 6 to 31 carbon atoms, where it can be substituted further, with the proviso that the maximum number of carbon atoms of 31 C atoms is not exceeded. Preferred substituents are methyl groups. The hydroxy-fatty acid can be saturated or unsaturated.

The acid group of the hydroxy-fatty acid can be free or esterified, preferred esters are methyl, ethyl, and hexyl esters. Furthermore, the acid group may form a lactone, preferably a lactone with a hydroxyl group of the glucose residue to which it is not already glycosidically bonded, preferably to the 4-hydroxyl group of the glucose residue to which it is not already glycosidically bonded.

Preferably, the hydroxy-fatty acid is a 17-hydroxyoctadecen-9-oic acid, preferably 17-hydroxyoctadecen-9(Z)-oic acid or its ester as defined hereinabove, or a corresponding lactone as defined hereinabove.

Sophorolipidic acid (SLA) is understood as meaning those sophorose/fatty acid conjugates which have a free acid group.

Sophorolipid lactone (SLL) is understood as meaning those sophorose/fatty acid conjugates whose acid group has formed a lactone in the above sense.

Sophorolipid esters (SLE) is understood as meaning those sophorose/fatty acid conjugates whose acid group is esterified with an alcohol. Preferred esters are methyl esters (SLEM), ethyl esters (SLEE) and hexyl esters (SLEH).

Particularly preferred are the sophorolipids of the formula (I):

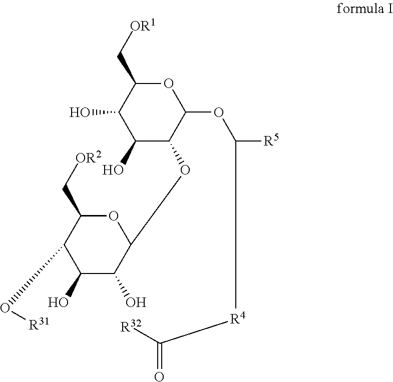

R¹ and R² independently of one another are either H, methyl groups and/or acetyl groups,

### R³¹ is H

R³² is H, a methyl, ethyl or hexyl group,
R³¹ and R³² together may represent a bond,
R⁴ independently of one another is a saturated or unsaturated divalent branched or unbranched organic group, the organic group is preferably a hydrocarbon group having 1 to 28 carbon atoms which can optionally be interrupted by amine, ester, amide or thioester groups, and the organic group is more preferably an alkylene group or alkenylene group having 2 to 28 carbon atoms, preferably 6 to 20 carbon atoms, more preferably 10 to 18 carbon atoms, especially preferably 14 to 16 carbon atoms, where the alkenylene group is optionally polyunsaturated, the alkenylene group is preferably monounsaturated, the alkenylene group is in particular a 17-yl-heptadeca-9-en-1-yl group, preferably a 17-yl-heptadeca-9-en-1-yl group.
R⁵ is H or a methyl group, preferably a methyl group,
with the proviso that the total number of the carbon atoms in the groups R⁴ and R⁵ do not exceed the number 29.

In the event that R³¹ and R³² together represent a bond, it takes the form of a lactone structure.

In the event of R⁴ is unsaturated, it preferably takes the form of double bonds, more preferably double bonds in the Z configuration; in the event of a plurality of double bonds, preferably at least one of the double bonds is in the Z configuration.

Particularly preferred are sophorolipids of the formula (II)

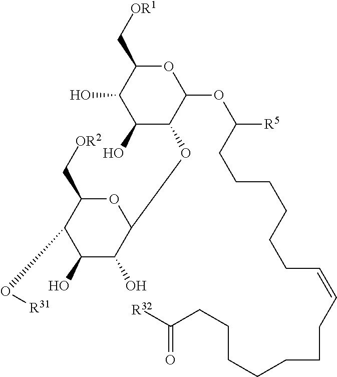

where the indices are as defined hereinabove.

Wherever molecules or molecule fragments have one or more stereocentres or can be differentiated into isomers on account of symmetries or can be differentiated into isomers on account of other effects e.g. restricted rotation, all possible isomers are included by the present invention. Isomers are known to the skilled person; the reader is referred particularly to the definitions given by Professor Kazmaier of the Saarland University, e.g. http://www.uni-saarland.de/fak8/kazmaier/PDF_files/vorlesungen/Stereochemie%20Strassb%20Vortage.pdf.

The sophorolipids can be synthetic or semisynthetic in nature or else may have been isolated, as a natural substance, from a live organism of the biosphere or from another source. The sophorolipids are preferably obtained via the biotechnological route. Preferably, the sophorolipids are produced with the aid of fungi which are non-pathogenic to humans (risk class 1, TRBA 460), especially preferred organisms are Yarrowia lipolytica, Candida apicola, C. bororiensis, C. bombicola, Wickerhamiella domercqiae or Burkholderia spec., particularly preferred is Candida bombicola, which is synonymously also referred to as, for example, Torulopsis bombicola or Starmerella bombicola.

The biotechnological products are furthermore preferably used without isolating the individual natural substances contained therein; for derivatizing with the aid of chemical reactions, the biotechnological product is used without isolation. Thus, for example, esters of the sophorolipids can be obtained by reacting the biotechnological products with esterification reagents. Esterification reagents are known to the skilled worker, for example acid anhydrides, acid chlorides or activated acids.

For the purposes of the invention, sophorolipids (SL) are mixtures of substances as described hereinabove. Preferably, sophorolipids (SL) contain the above-defined SLAs, SLLs and/or SLEs.

Especially preferred are sophorolipidic acids in which the radicals R¹ and R² and the radicals R³¹ and R³² are hydrogen, the radical R⁵ is a methyl group and the radical R⁴ is an alkylene radical or alkenylene radical having 15 carbon atoms, preferably an alkenylene radical, in particular a pentadec-8-enylene radical, with the enumeration within the alkenylene radical starting at the binding site of the carbonyl carbon.

In particular, the sophorolipid supply compositions contain not only the sophorolipids, but also free fats, fatty acids and/or oils from the biotechnological process as they are described in US 2012/0220464. These free fats, fatty acids and/or oils are not bound to the sophorolipids.

Active substances are those which are approved and/or registered and/or listed in the individual countries for use on plants and crops in order to protect plants against damage, or to avoid the yield loss as the result of pests or the like in a crop, or to eliminate undesirable accompanying flora, such as broad-leaved weeds and/or grass weeds, or to supply the plants with nutrients (also termed fertilizers). Active substances may be of synthetic nature or else of biological nature. Active substances may also be extracts, or natural substances, or antagonistically active organisms. They are usually also referred to as pesticides or plant protection agents. In general, active substances are incorporated into formulations for handling and efficiency purposes.

For their use on plants or plant parts, plant protection agent formulations are, in most cases, diluted with water before the usual spraying through nozzles, and contain, besides the active component, other adjuvants too, such as emulsifiers, dispersing aids, antifreeze agents, antifoams, biocides and surface-active substances such as surfactants. Active substances, in particular fungicides, insecticides and nutrients, can also, alone or in combination, be provided with the above-stated other adjuvants, applied to seeds (seed) of plants, using a variety of methods. Such methods are also referred to as seed treatment methods. The treatment of seed with fungicides and insecticides can protect plants in the early stage of their growth from diseases and attack by insects.

Examples of active substances are listed in ‘The Pesticide Manual’, 15th edition, 2009, The British Crop Protection Council, or in ‘The Manual of Biocontrol Agents’, 2004, The British Crop Protection Council. However, the invention is not limited to the stated active substances, but also comprises those of the prior art.

In the case of the sophorolipids, their active component content is explained by the content, in % by weight, of the total of all sophorolipids, preferably based on the total of SLA, SLL and SLE.

The pesticides, which are named after their field of use in crop protection and which can be combined with sophorolipids, include the following classes: all acaricides (AC), algicides (AL), attractants (AT), repellents (RE), bactericides (BA), fungicides (FU), selective herbicides (HE), insecticides (IN), agents/compositions against slugs and snails (molluscicides, MO), nematicides (NE), rodenticides (RO), sterilants (ST), virucides (VI), growth regulators (PG), plant strengthening agents/compositions (PS), micronutrients (MI) and macronutrients (MA). These names and the fields of application are known to the skilled worker. Active substances are employed alone or in combination with other active substances. Preferred pesticides are FU, IN, PG, MI and in particular fungicides and insecticides, especially preferably fungicides.

The compositions as per their use can be supply compositions and use compositions, they differ in their different sophorolipid content. The specifications hereinabove and hereinbelow relate to both forms of compositions, unless the terms “supply compositions” or “use compositions” are mentioned expressly.

### Supply Compositions:

Furthermore preferred is the use according to the invention of compositions for supplying the sophorolipids from the production process for the preparation of use compositions comprising the active components, the sophorolipids (SL), with a content of from 5 to 98% by weight, preferably a content of from 20 to 80% by weight and especially preferably of from 30 to 70% by weight, based on the total composition.

In the case of the solids content of the sophorolipid supply compositions, their content in % by weight, based on the total of all sophorolipids plus the components which have not been separated, is explained by the biotechnological process based on the used solution, emulsion and/or dispersion of the sophorolipids in a solvent, emulsifier and/or dispersant.

### Use Compositions:

Furthermore preferred is the use according to the invention of compositions for use on the crop plant with a content of from 0.001 to 1% by weight of active components, the sophorolipids (SL), preferably of from 0.01 to 0.7% by weight and especially preferably of from 0.1 to 0.5% by weight, based on the total composition. These use compositions are preferably prepared by diluting the supply compositions with water.

Preferably, the sophorolipids are used in accordance with the invention in compositions together with fungicides from the class of the strobilurins, of the triazoles, of the carboximides, of the benzophenones, of the morpholines and of the contact fungicides, such as chlorothalonil.

Furthermore preferred is the use according to the invention of sophorolipids in compositions which, besides a pesticide, contain further additives. The additives are preferably adjuvants, emulsifiers and/or formulation aids.

Furthermore, the use according to the invention of compositions containing sophorolipids together with a fungicide, where the sophorolipids together with the fungicide provide a synergistic effect in increasing yields. Preferably, the compositions containing sophorolipids and at least one carboximide have a synergistic effect in increasing yields. The yield increase is preferably a biomass increase.

Within the context of the invention, synergism is taken to mean that the effect of the combination of pesticide and sophorolipid exceeds the expected additive effect of the individual components. According to Berenbaum (M. C. Berenbaum: “What is Synergy?” Pharmacological Reviews, Vol. 1989, No. 41, page 98, section (g)) a synergistic effect exists when the effect E(da,db)>E(da)+E(db), where E(da,db) represents the effect of the combination of two components (a, b) for defined dosages (d) and E(da) and E(db) represent the activities of the individual components at the tested dosages.

Especially preferred are compositions as per use, which contain carboximides and sophorolipids.

Furthermore preferred is the use according to the invention of sophorolipids and/or their compositions on the leaves of crop plants and/or as a seed treatment agent/composition.

Furthermore preferred is the use of sophorolipids for the treatment of seed at dosage rates of from 0.1 to 5 g, preferably of from 0.5 to 3 g, particularly preferably of from 0.7 to 1.5 g of active component per kilogram of seed.

Furthermore preferred is the use according to the invention of compositions where the yield increase is based on a crop increase.

Likewise preferred is the use according to the invention of compositions where the yield increase is based on an increased rooting of seeds and seed.

Seed treatment is the treatment of seeds such as, for example, cereal kernels, maize kernels and the like; frequently, the term seed dressing or simply seed treatment product is used in the prior art.

A seed treatment with sophorolipids surprisingly accelerates and improves the early development of plants when they form roots and shoots.

The field trials carried out within the scope of the invention demonstrate that sophorolipids have a yield-increasing effect on agriculturally useful plants. This yield increase has been achieved both in combination with active substances and without active substances. Furthermore, it was demonstrated that the yield-increasing effect of the sophorolipids was also observed when the pesticides, in particular fungicides, were unable to demonstrate their pesticidal activity due to the absence of pathogens.

The examples show that the use of sophorolipids for increasing the yield of agriculturally useful plants is possible for a multiplicity of crop plants. The effect can be observed equally on monocotyledonous and dicotyledonous plants.

Since the synergistic effects have been observed in two different crop plants, two different groups of angiosperms, both monocotyledonous and dicotyledonous, it can be assumed that synergistic effects may also be possible for other plants. Furthermore, it can be assumed that other pesticidal active substances, too, demonstrate synergistic effects together with sophorolipids if the sophorolipids are employed in combination with an active substance content of approx. 50-500 g/ha, in particular of 100-200 g/ha.

The use according to the invention of sophorolipids and the use according to the invention of compositions containing at least one sophorolipid are described hereinbelow by way of example, without it being intended that the invention be limited to these exemplary embodiments. References below to ranges, general formulae or classes of compound should be taken to encompass not only the corresponding ranges or groups of compounds that are explicitly mentioned, but also all sub-ranges and sub-groups of compounds that may be obtained by extracting individual values (ranges) or compounds. Where documents are cited in the context of the present description, it is intended that their content fully form part of the disclosure content of the present invention. Where % figures are given below, they are figures % by weight unless otherwise indicated. In the case of compositions, the % figures, unless otherwise indicated, are based on the overall composition. Where average values are reported below, the averages in question are mass averages (weight averages), unless otherwise indicated. Where measurement values are reported below, these measurement values, unless otherwise indicated, have been ascertained under a pressure of 101325 Pa and at a temperature at 25° C.

The sophorolipids according to the invention can be employed in all crop plants where yield increases contribute to economic success of the user, for example in all grain crops where the grains or seeds are harvested and used, such as in cereals, legumes, oilseed rape, sunflowers, cotton, but also when biomass production is of interest, as is the case in vegetables or grasses, or in industrially utilized plants, or in forestry plants.

Moreover, the sophorolipids according to the invention can be employed in combination or as coformulation with active substances which are suitable for the control of fungi, viruses, bacteria or insects, or selectively, without damaging the crop, as herbicide. Developments of coformulations or combined use are feasible with for example the substances which contain agents which bring about, in plants, systemic acquired resistance as the result of controlling the salicylic acid metabolism or induced systemic resistance by modulating the jasmonic acid balance, such as, for example, by DCINA (2,6-dichloroisonicotinic acid), BTH (benzo(1,2,3)-thiadiazolecarbothioic acid S-methyl ester) or by growth promoting rhizosphere bacteria, or agents/compositions which contain rhizobacteria or fungi which colonize plant roots.

Owing to the advantageous ecotoxicological profile and the very high biodegradability of this substance class, the use according to the invention of the sophorolipids corresponds to the basic principle of sustainable plant production in the spirit of the organic movement (see M. Renkin, 2003. “Envionmental profile of sophorolipid and rhamnolipid biosurfactants”, La Rivista Italiana delle Sostanze Grasse. Vol. 80/4. pages 249-252).

### Examples

Field trials and greenhouse and laboratory experiments were designed in which the crop plants were treated with different sophorolipid samples in different growth stages, examples being the cereals (barley and wheat), legumes (soybeans) and vegetables (tomato). The sophorolipid samples were applied alone or in combination with commercial plant protection products which contained active substances (fungicides) or else mixtures of active substances.

TABLE 1
Plant protection products used in Examples 1 to 9:

| Code | Trade name | Pesticides | Manufacturer |
|---|---|---|---|
| fung-1 | Amistar Opti | 250 g/l azoxystrobin + | Syngenta, |
| | | 500 g/l chlorothalonil | Basle Switzerland |
| fung-2 | Nativo | 500 g/l SC trifloxystrobin + | Bayer CropScience, |
| | | 250 g/l EW tebuconazole | Monheim, Germany |
| fung-3 | Capalo | 75 g/l metrafenone + | BASF, |
| | | 62.5 g/l epoxyconazole + | Ludwigshafen, |
| | | 200 g/l fenpropimorph | Germany |
| fung-4 | Stratego | 375 g/l trifloxystrobin + | BayerCropScience, |
| | YLD | 125 g/l prothioconazole | Monheim, Germany |
| fung-5 | Seguris | 125 g/l isopyrazam + | Syngenta |
| | | 90 g/l epoxyconazole | Basle, Switzerland |

TABLE 2
Identity of the sophorolipid compositions as per use

| Code | Sophorolipid: | Composition of the supply composition |
|---|---|---|
| SL-1 | sophorolipid ethyl ester (SEE) | 100% solids, of which 70% by weight |
| | | sophorolipid active component |
| SL-2 | mixture of SLL (60% by weight) | aqueous with 45% by weight solids content; |
| | and SLA (40% by weight) | approx. 35% by weight of sophorolipid active |
| | | component in the aqueous product, |
| | | plus 2.6% by weight of oil |
| SL-3 | mixture of SLL (40% by weight) | aqueous with 41% by weight solids content; |
| | and SLA (60% by weight) | approx. 39% by weight of sophorolipid active |
| | | component in the aqueous product; |
| | | plus 0.5% by weight oils |
| SL-4 | mixture of SLL(60% by weight) | aqueous with 40% by weight solids content; |
| | and SLA (40% by weight) | 38% by weight sophorolipid active component in |
| | | the aqueous product; |
| | | plus 7% by weight oils |
| SL-5 | mixture of SLL (20% by weight) | aqueous with 41% by weight solids content; |
| | and SLA (80% by weight) | approx. 39% by weight sophorolipid active |
| | | component in the aqueous product; |
| | | plus <1% by weight oils |
| SL-6 | mixture of SLL (30% by weight) | aqueous with 50% by weight solids content; |
| | and SLA (70% by weight) | 40% by weight sophorolipid active component in |
| | | the aqueous product; |
| | | plus 10% by weight oils |
| SL-7 | mixture of SLL (10% by weight) | aqueous with 40% by weight Solids content; |
| | and SLA (90% by weight) | approx. 38% sophorolipid active component in |
| | | the aqueous product; <1% oil |

The solids content of the sophorolipid supply compositions is explained on the basis of the total, in a solution, emulsion or dispersion, of all sophorolipids plus the components from the biotechnological process which have not been separated off.

TABLE 3
Comparative product, not according to the invention

| Code | Trade name | | Manufacturer |
|---|---|---|---|
| AA-3 | Break-Thru S240 | organo-modified | Evonik Industries AG, |
| | | trisiloxane (active | Essen |
| | | substance content | |
| | | 765 g/l) | |

### General Description of the Field Trials

The design of field trials for testing fungicides in various types of cereals or legumes is known to the skilled worker in principle, so the procedure will only be described herein by way of summary:

Plots of 10 to 37 m² were randomly distributed in blocks with four replications in fields with uniformly grown cereals (barley, wheat) and legumes (soybeans). The plants in the four plots for each treatment were sprayed without or with fungicides (Table 1) or sophorolipid samples (Table 2) or adjuvant (Table 3): alone or in combination fungicide plus sophorolipid or adjuvant. For the spraying, the products were diluted with water (use composition) and, using a nozzle, applied to the plants with 100 to 3001 water/ha. In some cases, the spray was repeated after an interval of 2 to 3 weeks. The disease symptoms caused by fungal attack on the leaves of the crop plants were determined on different days after the spraying of the plants using a representative number of plants in each plot, proceeding in the manner with which the skilled worker is familiar. The disease level of the entirely untreated control was likewise scored. The disease symptoms are stated as the total of the leaf areas infected by one and/or more diseases (in % of the leaf area). This method is clear to a person skilled in the art.

At the time of grain ripening of the cereals and the legume, the plots of each treatment were harvested, and the grain weights were weighed for each plot. The moisture content of the grains was determined, and the yields per plot were calculated for a specific uniform fresh weight so as to compensate for fresh weight irregularities between the individual plots. These methods are familiar to those skilled in the art. Thereafter, the grain weight per plot was used to calculate the mean yield performance of the 4 plots and converted for a uniform area of one hectare in size. This procedure is likewise known to a person skilled in the art.

Infection with the plant pathogens was not induced, but took place via the environment.

### Example 1: Spring Wheat—Rust and Septoria

In suitable plots in a field with spring wheat cv. “SY 200”, fung-2 and SL-1 were diluted with 200 I/ha and applied to the plants at the beginning of the grain development (growth stage GS 73) and the milk stage of grain (GS 83). The disease symptoms on leaves caused by wheat rust and wheat Septoria were determined on the second leaf below the flag leaf 7 days after the first application, and the disease caused by both diseases was determined on the first leaf below the flag leaf 14 days after the first application. The disease symptoms are indicated as the sum of the area infected with both diseases (in % of the leaf area which was infected by both diseases). This method is clear to a person skilled in the art. After the crop was harvested, the grain yields were weighed. The application rates of the compositions and the results are shown in Table 4.

TABLE 4
Grain yields and disease symptoms of the leaves as per Example 1:

| | | Disease symptoms | |
|---|---|---|---|
| | Grain yield | [%] | |
| Treatment | [dt/ha] | 7 days | 14 days |
| Untreated | 62.8 | 45 | 85 |
| 800 ml fung-2/ha | 66.3 | 10 | 30 |
| 500 g SL-1/ha | 67.1 | 30 | 90 |
| corresponds to 350 g/ha active SL | | | |
| component | | | |

The results show that the yields for the treatment with fung-2 rose by 3.5 dt/ha in comparison with the untreated plots; conceivably, this might be attributed to control of the pathogens in the plots. The use of the sophorolipid SL-1 increased the yields by 4.3 dt/ha, that is to say beyond the value which was achieved with the fungicide treatment alone. This cannot be attributed to improvement in disease control since the disease incidence in the SL-1 treated plots was nearly identical to that in the untreated plots.

### Example 2: Spring Wheat—Rust and Septoria

In suitable plots in a field with spring wheat cv. “ACA 901”, fung-2 together with various amounts of SL-3 and SL-4 was diluted with 200 I/ha and applied to the plants at the beginning of the grain development (growth stage GS 73) and the milk stage of grain (GS 83). SL-2, likewise diluted with 2001/ha, was sprayed at 1100 ml/ha alone. The disease symptoms of the leaves which were caused by rust and septoria were determined on the flag leaf (FL) and the first leaf below the flag leaf (FL-1) 14 days after the first application. The disease level in % of each leaf is the sum of the disease incidence caused by both diseases. After the crop was harvested, the grain yields were weighed. The application rates of the compositions and the results are shown in Table 5.

TABLE 5
Grain yields and disease symptoms of the leaves as per Example 2:

| | | Disease symptoms | |
|---|---|---|---|
| | Grain yield | [%] | |
| Treatment | [dt/ha] | FL | FL-1 |
| Untreated | 60.7 | 15 | 40 |
| 800 ml fung-2/ha | 63.5 | 0 | 5 |
| 800 ml fung-2 + 1250 ml SL-3/ha | 67.5 | 0 | 2 |
| correspond to 488 g/ha active | | | |
| SL component | | | |
| 800 ml fung-2 + 625 ml SL-4/ha | 68.7 | 0 | 7 |
| correspond to 237 g/ha active | | | |
| SL component | | | |
| 1100 ml SL-2/ha | 71.1 | 10 | 40 |
| correspond to 385 g/ha active | | | |
| SL component | | | |

As can be seen from Table 5, the fungicide fung-2 decreased the disease symptoms of the leaves considerably in comparison with the untreated control. Here, grain yield increased by 2.8 dt/ha. The yields increased further by the combination of the fungicide with 237/488 g/ha sophorolipids (SL) (by 4 and 9.1 dt/ha, respectively, in comparison with fung-2 alone), and this further yield increase does not correlate with any improvement in disease control. A dose dependency of the sophorolipid was not observed within this concentration range. The sophorolipid SL-2, when used on its own, increased the yields by more than 10 dt/ha in comparison with the untreated control. No change in the disease symptoms as the result of SL-2 application was observed since the disease level of the leaves was identical to that in the control. Therefore, the yield increase caused by SL-2 cannot be attributed to an improvement of disease control.

### Example 3: Soybeans—without Diseases

In a field with soybeans, the fungicide fung-4, diluted with 200 I/ha, was applied to the plants in the corresponding plots at growth stage R-1 (beginning of anthesis) and 21 days later. SL-3 and SL-5 were sprayed on their own without fung-4. During the experimental time, the plants were observed for diseases; however, no diseases occurred. The grain yields of this legume were weighed after the crop was harvested. The application rates of the compositions and the results are listed in Table 6.

The application rate of SL-3 and SL-5 corresponds to 487.5 g of active SL component per ha.

TABLE 6
Grain yields as per Example 3:

| Treatment | Grain yield [dt/ha] |
|---|---|
| Untreated | 37.0 |
| 350 ml fung-4/ha | 37.3 |
| 1250 ml SL-3/ha | 38.7 |
| 1250 ml SL-5/ha | 38.5 |

No diseases were observed in this soybean trial. Accordingly, the fungicide could not display any activity in relation to a disease. A yield increase over the control, caused by fung-4 on its own, was not observed. When, however, the two sophorolipids were used on their own, then the yields increased in the range of from 1.2 to 1.7 dt/ha. The yield increases were achieved by the sophorolipids alone.

### Example 4: Winter Wheat—Septoria tritici

In a field with winter wheat cv. “Cubus”, the fungicide combination fung-3 on its own, or together with SL-2, diluted with 2001/ha, were sprayed in corresponding plots at the beginning of the vegetation period in spring at growth stage 33 (plants have formed 3 nodes) and 20 days later. The disease symptoms caused by the fungus Septoria tritici on the leaves were determined on the second leaf below the flag leaf 13 days after the first spray application and on the first leaf below the flag leaf 13 days after the second spray treatment. The grain yields were weighed after the plots had been harvested. The application rates of the compositions and the results are shown in Table 7.

The application rate of SL-2 corresponds to 192.5 g of active SL component per ha.

TABLE 7
Grain yields and disease symptoms of the leaves as per Example 4:

| | | Disease | Disease |
|---|---|---|---|
| | Grain yield | symptoms | symptoms [%], |
| Treatment | [dt/ha] | [%], first scoring | second scoring |
| Untreated | 36.9 | 23.8 | 18.5 |
| 1000 ml fung-3/ha | 36.4 | 14.3 | 9.5 |
| 1000 ml fung-3 + | 39.4 | 14.3 | 6.3 |
| 550 ml SL-2/ha | | | |

Table 7 shows the yield increase due to the use of sophorolipids. When the fungicide was used, no yield increase was observed.

### Example 5: Winter Barley—Mildew and Net Blotch

In a field with winter barley cv. “Friderikus”, the leaves were sprayed once at growth stage 39 to 41 (flag leaf fully developed, beginning of ear emergence). To this end, the plants were either treated with 1.5 I/ha fung-1, or applied with 0.5 I/ha SL-3 alone, diluted with 200 I/ha. 14 days after the application, the disease symptoms of the plants were examined for infestation with mildew (Blumeria graminis) and net blotch disease (Pyrenophora tens), and 29 days after application only for net blotch disease. After the harvest, the grain yield was measured. The application rates of the compositions and the results are shown in Table 8.

The application rate of SL-3 corresponds to 195 g of active SL component per ha.

TABLE 8
Grain yields and disease symptoms of the leaves as per Example 5:

| | | | | Disease |
|---|---|---|---|---|
| | | Disease | Disease | symptoms |
| | | symptoms | symptoms | [%] |
| | | [%] | [%] | Net blotch, |
| | Grain yield | Mildew, | Net blotch, | second |
| Treatment | [dt/ha] | first scoring | first scoring | scoring |
| Untreated | 60.4 | 17 | 5 | 7 |
| 1.5 l/ha fung-1 | 65.3 | 11 | 0 | 4 |
| 0.5 l/ha SL-3 | 67.3 | 17 | 3 | 6 |

The results of Table 8 show that the yields for the treatment with fung 1 rose by 4.9 dt/ha in comparison with the untreated plots; this may possibly be attributed to the fact that the plant pathogens were controlled in part. The sophorolipid SL-3 on its own increased the yields by 6.9 dt/ha. This increase cannot be attributed to improved disease control since the disease symptoms were virtually identical to those of the untreated control.

### Example 6: Winter Barley

In a field with winter barley cv. “Lomerit”, a single application of fung-1 alone or together with the sophorolipids SL-1 or SL-6 was applied at growth stage 39 (flag leaf fully developed). After the treatment in this experiment, a medium to severe incidence of various diseases of barley, which were also scored at different points in time, was observed in the untreated controls. The fungicide on its own did not fully control these diseases. The application rates of the sophorolipids were 175 g/ha (SL-1) and 200 g/ha (SL-6). The results are shown in Table 9.

TABLE 9
Grain yields as per Example 6:

| Treatment | Grain yield [dt/ha] |
|---|---|
| Untreated | 45.5 |
| 1.5 l/ha fung-1 | 50.6 |
| 1.5 l/ha fung-1 + 250 g/ha SL-1 | 55.6 |
| corresponds to 175 g/ha active SL | |
| component | |
| 1.5 l/ha fung-1 + 500 ml/ha SL-6 | 57.0 |
| corresponds to 200 g/ha active SL | |
| component | |

The fungicide treatment increased the grain yields by 5.1 dt/ha. The sophorolipids increased the yields by a further 5 dt/ha (SL-1) and 6.4 dt/ha (SL-6).

### Example 7: Winter Barley—Net Blotch Disease (not According to the Invention)

In a field with winter barley cv. “Lomerit”, fung-1 was applied once, either alone or together with a commercial adjuvant (BREAK-THRU S240, Evonik Industries AG). In this context, the compositions were dissolved in 200 I/ha and sprayed onto the plants in growth stage 39 (flag leaf fully developed). 28 days after the application, the incidence of net blotch disease was scored on the leaf below the flag leaf. After the harvest, the grain yields were determined. The yield results are shown in Table 10.

TABLE 10
Grain yields as per Example 7:

| | | Disease |
|---|---|---|
| Treatment | Grain yield [dt/ha] | symptoms [%], |
| Untreated | 33.5 | 20 |
| 1.5 l/ha fung-1 | 39.2 | 9.3 |
| 1.5 l/ha fung-1 + 0.2 l/ha AA-3 | 38.3 | 5.8 |

Table 10 shows that with the fungicide treatment a yield increase of 5.7 dt/ha was observed, and the disease symptoms were simultaneously also markedly decreased. The combined use of the fungicide together with the commercial adjuvant resulted in a further improvement of the disease control. According to US 2012/0220464, this situation can be expected.

A further yield increase by the adjuvant has not been observed.

Commercially available adjuvants can enhance the activity of fungicides for disease control, but this does not result in a yield-increasing effect.

### Example 8: Use as Cereal Seed Treatment Agent

In the laboratory, barley seeds cv. “Lawina” were surface-sterilized (2 min, 70% v/v ethanol; 1.5 h; 6% by weight aqueous sodium hypochlorite solution; 4 h washing in water with at least three water changes) and, in a humid chamber, pre-treated for at least 3 days on filter paper which had been moistened with 1 mM CaSO₄. The seeds were grown under steril conditions on agar in glass vessels on agar (consisting of 0.4% by weight Gelrite® (trade mark of Carl Roth, GmbH+Co. KG)), with 2.15 g/l MS salts (Murashige and Skoog basal salt mixture (MS), from Sigma-Aldrich No. M 5524; http://www.sigmaaldrich.com/life-science/molecular-biology/plant-biotechnology/tissue-culture-protocols/murashige-skoog.html).

Short before pouring the liquid agar into the glass vessels (at 40° C.), the filter-sterilized sophorolipids SL-5, SL-7 and the fungicide fung-5 were added at the relevant concentrations to the agar while still liquid (calculated on the basis of the volume of the added agar). The seeds were then placed on the agar. This procedure simulated a seed treatment since the agents were then capable of directly influencing the germination and initial growth of the plants. The plants were grown during 10 days in the laboratory under ambient temperatures. After 10 days, the number of lateral roots formed were counted for the agar-grown plants. The shoot length was additionally measured.

TABLE 11
Germination and growth as per Example 8

| | concentration | | |
|---|---|---|---|
| Treatment | ([mg/l] agar) | Number of roots | Shoot length [cm] |
| Control | — | 7 | 1.7 |
| SL-5 | 500 | 9 | 2.8 |
| | corresponds to 195 mg | | |
| | active SL component | | |
| | per I agar | | |
| SL-5 | 1000 | 9 | 2.3 |
| | corresponds to 390 mg | | |
| | active SL component | | |
| | per I agar | | |
| SL-7 | 500 | 10 | 3.2 |
| | corresponding to | | |
| | 190 mg active SL | | |
| | component per I agar | | |
| fung-5 | 500 | 7 | 1.6 |

Table 11 shows that the sophorolipids not only enhanced root growth, but also shoot length, and therefore increased the plants' biomass production. The fungicide fung-5 had no effect on these parameters.

### Example 9: Synergisms with Fungicides on Yield Formation in Barley and Tomato

Barley cv. “Lawina” was sown in a mixture of two parts of expanded clay Seramis® (trade mark of Seramis GmbH, Mogendorf, Germany) and one part of Oil Dri (Damolin GmbH, Oberhausen, Germany) and, at a rate of in each case three plants per pot, grown in a controlled-environment cabinet at a 22° C./18° C. day/night cycle, 69% relative atmospheric humidity and a photoperiod of 14 h (240 μmol*m⁻²*s⁻¹ photon flux density, PFD). The plants were fertilized weekly with 20 ml of a 0.25% by weight strength solution of Wuxal Top N (Schering N/P/K: 12/4/6) 1.

Tomatoes cv. “Moneymaker” were sown in Frustorfer compost Flormaris®, special mixture “fein” (trade mark of Flormaris GmbH+Co. KG, Wangerland, Germany). When the roots had reached a length of approx. 1 cm, the plants were picked out individually and planted into pots which contained, as substrate, 200 ml of a mixture of two parts of expanded clay (Seramis) and one part of Terra Greene (trade mark of Oil-Dri Corp., Chicago, USA). During the entire cultivation and observation period, plants remained in the abovementioned controlled-environment cabinet.

Spray applications with the test substances, dissolved in water, were administered to the leaves of barley and tomato at an equivalent of 200 I/ha spray liquor, calculated on the basis of the pot surface, when the barley and tomato had reached the 3 to 4-leaf growth stage. 21 days after the application, growth evaluations were performed—during these 21 days, the plants remained in the above controlled-environment cabinets.

Shoot growth was determined by cutting the aerial shoot portions at the interface with the substrate, whereupon the fresh weight was determined immediately. To determine the shoot growth increment, the difference between the means of four treated test plants and untreated controls was calculated. The yield increment is based on the mean weight per plant.

The results are shown in Tables 12 and 13. The dosage rates for SL-7 were identical in all experiments, as shown in Table 12.

TABLE 12
Shoot growth increments of barley as per Example 9

| | | Shoot growth | Yield |
|---|---|---|---|
| | | increment | increment |
| Treatment | Dosage rate [l/ha] | [g/pot] | [g] |
| SL-7 | 0.25 | 0.51 | — |
| | corresponds to 95 g active | | |
| | SL component per ha | | |
| SL-7 | 0.5 | 0.36 | — |
| | corresponds to 190 g active | | |
| | SL component per ha | | |
| fung-5 | 1.0 | 0.55 | — |
| SL-7 + fung-5 | 0.25 + 1.0 | 1.27 | +0.21. |
| SL-7 + fung-5 | 0.5 + 1.0 | 0.95 | +0.04 |

TABLE 13
Shoot growth increment of tomato as per Example 9

| | Dosage rate | Shoot growth increment | Yield |
|---|---|---|---|
| Treatment | [l/ha] | [g/pot] | increment [g] |
| SL-7 | 0.25 | 0.18 | — |
| SL-7 | 0.5 | 0.53 | — |
| fung-5 | 0.5 | 0.54 | — |
| SL-7 + fung-5 | 0.5 + 0.5 | 1.11 | +0.04 |

Tables 12 and 13 show that the joint use of sophorolipid and a fungicide of the class of the carboximides resulted in a synergistically increased yield in the form of the plants' biomass.

Since the synergistic effects have emerged in two different crop plants, two different groups of the angiosperms, both monocotyledonous and dicotyledonous, it can be assumed that synergistic effects will also be possible for other plants. It can furthermore be assumed that other pesticidal active substances, too, demonstrate synergistic effects with sophorolipids when the sophorolipids are employed in combination at a rate of approximately 50-500 g/ha active substance, but in particular at 100-200 g/ha active substance.

1: A method, comprising:
treating an agriculturally useful plant with a composition comprising a sophorolipid active component,
wherein the treating increases the yield of the agriculturally useful plant.

2: The method according to claim 1, wherein the agriculturally useful plant is infected with a phytopathogenic organism.

3: The method according to claim 2, wherein the sophorolipid does not influence a disease symptom of the phytopathogenic organism.

4: The method according to claim 1, wherein the agriculturally useful plant is treated with the composition comprising the sophorolipid active component at a dosage rate of from 50 to 1000 g of the sohporolipid active component per hectare of the agriculturally useful plant.

5: The method according to claim 1, wherein the agriculturally useful plant is treated with a composition comprising the sophorolipid active component at a dosage rate of from 0.1 to 5 g, of the sophorolipid active component per kilogram of seed of the agriculturally useful plant.

6: The method according to claim 1, wherein the composition further comprises at least one pesticide suitable for treating a phytopathogenic organism.

7: The method according to claim 6, wherein the pesticide is at least one fungicide selected from the group consisting of strobilurins, triazoles, carboximides, benzophenones, morpholine and contact fungicides.

8: The method according to claim 6, wherein the composition further comprises an additive.

9: The method according to claim 6, wherein the pesticide is a fungicide which has a synergistic effect with the sophorolipid in terms of increasing the yield of the agriculturally useful plant.

10: The method according to claim 9, wherein the fungicide is a carboximide.

11: The method according to claim 6, wherein the treating with the composition comprises applying the composition to the leaves of crop plants, providing the composition as a seed treatment agent, or both.

12: The method according to claim 6, further comprising
preparing the composition from a supply composition obtained by a production process for a preparation of the sophorolipid prior to the treating,
wherein the supply composition has a sophorolipid active component content of from 5 to 98% by weight based on the total weight of the composition.

13: The method according to claim 6, wherein the composition during the treating has a sophorolipid active component content of from 0.001 to 1% by weight based on the total weight of the composition, and
wherein the treating comprises applying the composition to a crop plant.

14: The method according to claim 6, wherein the yield increase is in terms of a crop increase, a biomass increase, or both.

15: The method according to claim 6, wherein the yield increase is in terms of a rooting of seeds increase and a seed increase.

16: A composition, comprising:
a sophorolipid active ingredient, and
at least one pesticide suitable for treating a phytopathogenic organism.

17: The composition according to claim 16, wherein the pesticide is at least one fungicide selected from the group consisting of strobilurins, triazoles, carboximides, benzophenones, morpholins, and contact fungicides.

18: The composition according to claim 16, further comprising at least one additive selected from the group consisting of an adjuvant, an emulsifier, and a formulation aid.

19: The composition according to claim 16, wherein the composition has a sophorolipid active ingredient composition of 0.001 to 1% by weight relative to the total weight of the composition.

20: The composition according to claim 16, wherein the composition has a sophorolipid active ingredient composition of 5 to 98% by weight relative to the total weight of the composition.
